(19) United States
(12) Patent Application Publication
(10) Pub. No.: US 2026/0064043 A1
(43) Pub. Date: Mar. 5, 2026

(54) DEVELOPING DEVICE AND IMAGE FORMING APPARATUS

(71) Applicants: Toshio KOIKE, Tokyo (JP); Hiroshi KIKUCHI, Kanagawa (JP); Hideki KIMURA, Kanagawa (JP); Yutaka TAKAHASHI, Kanagawa (JP); Michiharu SUZUKI, Kanagawa (JP); Tomoki TSUJI, Kanagawa (JP); Fumihiro HIROSE, Kanagawa (JP)

(72) Inventors: Toshio KOIKE, Tokyo (JP); Hiroshi KIKUCHI, Kanagawa (JP); Hideki KIMURA, Kanagawa (JP); Yutaka TAKAHASHI, Kanagawa (JP); Michiharu SUZUKI, Kanagawa (JP); Tomoki TSUJI, Kanagawa (JP); Fumihiro HIROSE, Kanagawa (JP)

(73) Assignee: Ricoh Company, Ltd., Tokyo (JP)

(21) Appl. No.: 19/296,421

(22) Filed: Aug. 11, 2025

(30) Foreign Application Priority Data
Aug. 29, 2024 (JP) 2024-147534

(51) Int. Cl. G03G 15/08

(52) U.S. Cl. CPC G03G 15/0898; G03G 15/0808

(57) ABSTRACT

A developing device includes a housing, an image bearer, a developer bearer, a suction port, and a toner receiver. The housing contains a developer including toner. The image bearer forms a latent image of the toner. The developer bearer bears the developer and supplies the toner. The suction port is disposed below the developer bearer to suck the toner outside the housing. The toner receiver is disposed below the suction port to receive the toner outside the housing. The toner receiver has a first angle between a line segment connecting a tip end of the toner receiver protruding from the housing and a lowermost end of the suction port and a horizontal line extending horizontally from the tip end of the toner receiver toward the housing. The toner receiver receives the toner having an angle of repose as a second angle. The first angle is larger than the second angle.

### CROSS-REFERENCE TO RELATED APPLICATIONS

This patent application is based on and claims priority pursuant to 35 U.S. C. § 119(a) to Japanese Patent Application No. 2024-147534, filed on Aug. 29, 2024, in the Japan Patent Office, the entire disclosure of which is hereby incorporated by reference herein.

### BACKGROUND

### Technical Field

Embodiments of the present disclosure relate to a developing device and an image forming apparatus.

### Related Art

An electrophotographic image forming apparatus such as a copier or a printer is known that supplies toner to a latent image formed on a surface of an image bearer such as a photoconductor to develop the latent image.

Such an image forming apparatus typically includes a developing device for supplying toner to a latent image on the image bearer. Typically, the developing device includes a developing roller as a developer bearer to bear a developer containing toner on a surface thereof. The developer that is borne on the surface of the developing roller is conveyed to a position facing the image bearer in accordance with the rotation of the developing roller, and the toner is supplied to the latent image on the image bearer. By so doing, the latent image is developed as a toner image.

A developing device is known that includes a suction port for sucking scattered toner and a toner receiver for receiving toner below the suction port. In the developing device, the toner that is scattered from the developing device is sucked from the suction port and collected.

### SUMMARY

In an embodiment of the present disclosure, a developing device includes a housing, an image bearer, a developer bearer, a suction port, and a toner receiver. The housing contains a developer including at least toner. The image bearer forms a latent image of the toner on a surface of the image bearer. The developer bearer bears the developer and supplies the toner to the surface of the image bearer. The suction port is disposed below the developer bearer to suck the toner outside the housing. The toner receiver is disposed below the suction port to receive the toner outside the housing. The toner receiver has a first angle between a line segment connecting a tip end of the toner receiver protruding from the housing and a lowermost end of the suction port and a horizontal line extending horizontally from the tip end of the toner receiver toward the housing. The toner receiver receives the toner having an angle of repose as a second angle. The first angle is larger than the second angle.

In another embodiment of the present disclosure, an image forming apparatus includes the developing device.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a configuration of an image forming apparatus according to a first embodiment of the present disclosure;

FIG. 2 is a schematic diagram illustrating a developing device according to the first embodiment of the present disclosure;

FIG. 3 is a schematic diagram illustrating a configuration of a suction port and a toner receiver and the surroundings thereof provided for the developing device of FIG. 2, according to the first embodiment of the present disclosure;

FIG. 4 is a schematic diagram illustrating a configuration of a bulk-density measuring device for measuring the angle of repose of toner;

FIG. 5 is a diagram illustrating an inclination angle of an inclined portion of the toner receiver of FIG. 3 according to the first embodiment of the present disclosure;

FIG. 6 is a diagram illustrating a developing device according to a comparative example of embodiments of the present disclosure; and

FIG. 7 is a diagram illustrating a configuration of a developing device according to a second embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, descriptions are given below of embodiments of the present disclosure. In the drawings for illustrating embodiments of the present disclosure, like reference signs are assigned to elements such as components and parts that have a like function or a like shape as far as distinguishable, and descriptions of such elements may be omitted once the description is provided.

### Configuration of Image Forming Apparatus

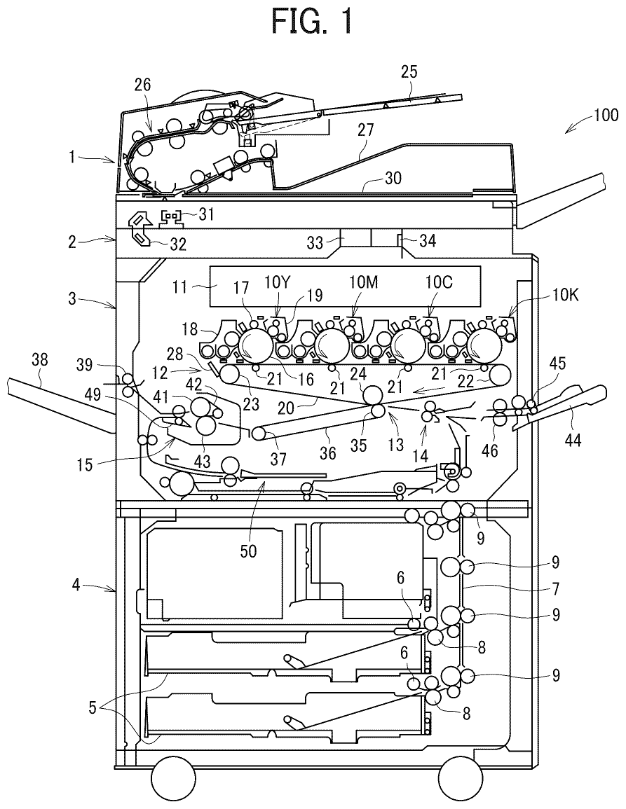

FIG. 1 is a schematic diagram illustrating a configuration of an image forming apparatus according to a first embodiment of the present disclosure.

Initially, with reference to FIG. 1, a description is given below of an overall configuration and operation of an image forming apparatus 100 according to the first embodiment. In the following description, the “image forming apparatus” includes a printer, a copier, a facsimile machine, a printing machine, or a multifunction peripheral having at least two of printing, copying, scanning, and facsimile functions. The term “image formation” includes the formation of images with meanings such as characters and figures and the formation of images with no meanings such as patterns.

The image forming apparatus 100 illustrated in FIG. 1 is an electrophotographic image forming apparatus that forms an image using toner as developer. The image forming apparatus 100 includes, for example, a document feeder 1 to convey a document, an image reader 2 to read an image of a document, an image former 3 to form an image, a sheet feeder 4 to supply a sheet as a recording medium.

The document feeder 1 includes a document tray 25 on which a document is placed, a document conveyance device 26 to convey the document from the document tray 25 onto an exposure glass 30 of the image reader 2, and an output tray 27 to which the document is ejected.

The image reader 2 includes a first carriage 31 including a light source, a second carriage 32 including a mirror, an imaging lens 33, and a reading sensor 34, in addition to the exposure glass 30.

The image former 3 includes multiple image forming units 10Y, 10M, 10C, and 10K to form images of colors of yellow (Y), magenta (M), cyan (C), and black (K), respectively, an optical writing device 11, an intermediate transfer device 12, a secondary transfer device 13, a timing roller pair 14, and a fixing device 15.

The multiple image forming units 10Y, 10M, 10C, and 10K have a same configuration except the image forming units 10Y, 10M, 10C, and 10K form images of different colors. The image forming unit 10Y is described as an example. The image forming unit 10Y includes a drum-shaped photoconductor 16 as an image bearer, a charging device 17 to charge the circumferential surface of the photoconductor 16, a developing device 18 to supply toner to the circumferential surface of the photoconductor 16 to form a toner image, and a cleaning device 19 to clean the circumferential surface of the photoconductor 16.

The optical writing device 11 irradiates the circumferential surfaces of the photoconductors 16 of the image forming units 10Y, 10M, 10C, and 10K with laser beams based on image data read by the image reader 2.

The intermediate transfer device 12 includes an intermediate transfer belt 20, multiple primary transfer rollers 21, a tension roller 22, a driving roller 23, a secondary transfer backup roller 24, and a belt cleaner 28. The intermediate transfer belt 20 is stretched by the primary transfer roller 21, the tension roller 22, the driving roller 23, and the secondary transfer backup roller 24.

The primary transfer rollers 21 are in contact with the circumferential surfaces of the respective photoconductors 16 with the intermediate transfer belt 20 interposed therebetween. Accordingly, primary transfer nips are formed between the intermediate transfer belt 20 and the photoconductors 16.

The secondary transfer device 13 includes a secondary transfer roller 35, a secondary transfer belt 36, and a tension roller 37. The secondary transfer belt 36 is stretched between the secondary transfer belt 36 and the tension roller 37. The secondary transfer roller 35 is in contact with the secondary transfer backup roller 24 with the secondary transfer belt 36 and the intermediate transfer belt 20 interposed therebetween. Accordingly, a secondary transfer nip is formed between the intermediate transfer belt 20 and the secondary transfer belt 36.

The fixing device 15 includes a heating roller 41 having a heat source inside the heating roller 41, a fixing belt 42, and a pressure roller 43. The pressure roller 43 is in contact with the heating roller 41 with the fixing belt 42 interposed between pressure roller 43 and the heating roller 41. Thus, a fixing nip is formed between the pressure roller 43 and the fixing belt 42.

The sheet feeder 4 includes multiple sheet trays 5 to accommodate sheets, feeding rollers 6 to feed a sheet from the respective sheet trays 5, separation rollers 8 to separate the fed sheet and supply the sheet to a sheet feed path 7, and conveyance roller pairs 9 to convey the sheet on the sheet feed path 7. In the present embodiment, a sheet of paper is used as the recording medium on which an image is formed. However, examples of the recording medium include not only a sheet of paper but also an overhead projector (OHP) sheet, a fabric, a metallic sheet, a plastic film, and a prepreg sheet including carbon fibers impregnated with resin in advance.

The image forming apparatus 100 according to the first embodiment includes a bypass feed tray 44 to manually feed a sheet, a bypass feed roller pair 45 to feed a sheet from the bypass feed tray 44, and a separation roller pair 46 to separate sheets one by one on a side wall (a right side wall in FIG. 1) of the housing of the image former 3.

The image forming apparatus 100 according to the first embodiment further includes an output tray 38 to which a sheet is ejected and an ejection roller pair 39 to eject a sheet to the output tray 38 on a side wall (a side wall on the left side in FIG. 1) of the image former 3, opposite the bypass feed tray 44.

Further, a reverse conveyor 50 that reverses front and back sides of the sheet and conveys the sheet is disposed below the secondary transfer belt 36 and the fixing device 15.

### Operation of Image Forming Apparatus

Subsequently, a description is given of the operation of the image forming apparatus 100 according to the first embodiment with reference to FIG. 1.

When printing is started while a document is placed on the document tray 25, the document is conveyed from the document tray 25 toward the exposure glass 30. When the document passes through a predetermined reading position on the exposure glass 30, light is emitted from the light source of the first carriage 31.

At this time, the reflected light that is reflected from the document is guided to the imaging lens 33 by the mirror of the second carriage 32 and is incident on the reading sensor 34 via the imaging lens 33. By so doing, a signal of the incident light is photoelectrically converted, and image data is generated. Subsequently, the document that has passed through the predetermined reading position is ejected to the output tray 27.

In a case in which the document is placed on the exposure glass 30 instead of the document tray 25, when the printing is started, the first carriage 31 and the second carriage 32 start to travel in parallel with the document on the exposure glass 30.

Light is emitted from the light source of the first carriage 31 toward the document, and the reflected light is guided to the imaging lens 33 by the mirror of the second carriage 32 and is incident on the reading sensor 34. By so doing, image data is generated.

When printing is started, the photoconductors 16 of the image forming units 10Y, 10M, 10C, and 10K start to be rotationally driven in the image former 3, and toner images of yellow, cyan, magenta, and black are formed on the surfaces of the respective photoconductors 16 through a charging process, an exposure process, and a developing process.

Specifically, the surfaces of the photoconductors 16 are charged to a uniform high potential by the charging device 17. Subsequently, the optical writing device 11 irradiates the surfaces (charged surfaces) of the photoconductors 16 with laser light based on the image data generated by the reading sensor 34. Accordingly, the potential of portions of the photoconductors 16 irradiated with the laser beam is lowered, and an electrostatic latent images are formed on the photoconductors 16 based on the image data. Subsequently, toner is supplied from the developing device 18 to the electrostatic latent images. By so doing, a toner image is formed on the surface of each of the photoconductors 16.

The toner images of yellow, cyan, magenta, and black formed on the respective photoconductors 16 reach the respective primary transfer nips at which the respective primary transfer rollers 21 are positioned with the rotation of the photoconductors 16. Then, the toner images of yellow, cyan, magenta, and black are sequentially transferred onto the intermediate transfer belt 20 to be superimposed one on another by transfer electric fields formed at the primary transfer nips. Thus, a full-color toner image is formed on the intermediate transfer belt 20.

The image formation is not limited to the case where a full-color image is formed using all of the four image forming units 10Y, 10M, 10C, and 10K, and a single-color image may be formed using any one of the image forming units 10Y, 10M, 10C, and 10K, or any of two color or three color image may be formed using any of the two or three image forming units 10Y, 10M, 10C, and 10K.

After the toner image is transferred, the cleaning device 19 cleans the photoconductors 16 to remove, for example, residual toner from the photoconductors 16.

The toner image that is transferred onto the intermediate transfer belt 20 is conveyed to the secondary transfer nip at which the secondary transfer roller 35 is positioned in accordance with the rotation of the intermediate transfer belt 20, and the toner image is transferred onto the sheet by the secondary transfer electric field formed in the secondary transfer nip. The sheet to which the toner image is transferred is a sheet of paper supplied from the sheet feeder 4 to the secondary transfer nip.

In the sheet feeder 4, one of the feeding rollers 6 starts rotating substantially at the same time as the start of the image reading operation by the image reader 2, and the sheet is fed from one of the sheet trays 5. The fed sheets are separated one by one by a separation roller pair 8, enter the sheet feed path 7, and are conveyed by the conveyance roller pairs 9.

When sheets are set on the bypass feed tray 44, the sheets are separated and supplied one by one by the rotational driving of the bypass feed roller pair 45 and the separation roller pair 46.

The sheet fed from the sheet tray 5 or the bypass feed tray 44 contacts the timing roller pair 14 at a position upstream from the secondary transfer nip in a sheet conveyance direction, and the conveyance of the sheet is temporarily stopped. Subsequently, as the timing roller pair 14 is driven to rotate, the sheet is conveyed to the secondary transfer nip in synchronization with the toner image on the intermediate transfer belt 20. Accordingly, the toner image on the intermediate transfer belt 20 is transferred to the sheet conveyed to the secondary transfer nip.

Subsequently, the sheet is conveyed to the fixing device 15. The sheet that is conveyed to the fixing device 15 enters a fixing nip between the fixing belt 42 and the pressure roller 43, and the toner image is fixed to the sheet by heat and pressure. After the toner image is transferred to the sheet, the belt cleaner 28 removes, for example, residual toner on the intermediate transfer belt 20.

When the single-sided printing is performed, the sheet is guided to the ejection roller pair 39 by a switcher 49 disposed downstream from the fixing device 15 in the sheet conveyance direction, and the sheet is ejected to the output tray 38 by the ejection roller pair 39.

Alternatively, when the duplex printing is performed, the sheet conveyance path is switched by the switcher 49. By so doing, the sheet is guided to the reverse conveyor 50. Subsequently, the reverse conveyor 50 reverses the sheet to supply the sheet to the secondary transfer nip again, and the toner image, which is formed through the image forming process (the charging process, the exposure process, and the developing process) similar to the above-described image forming process, is transferred to the back side of the sheet.

After the fixing device 15 fixes the image onto the back side of the sheet, the sheet is ejected to the output tray 38 by the ejection roller pair 39. Accordingly, a series of operations of the image forming apparatus 100 is completed.

### Configuration of Developing Device

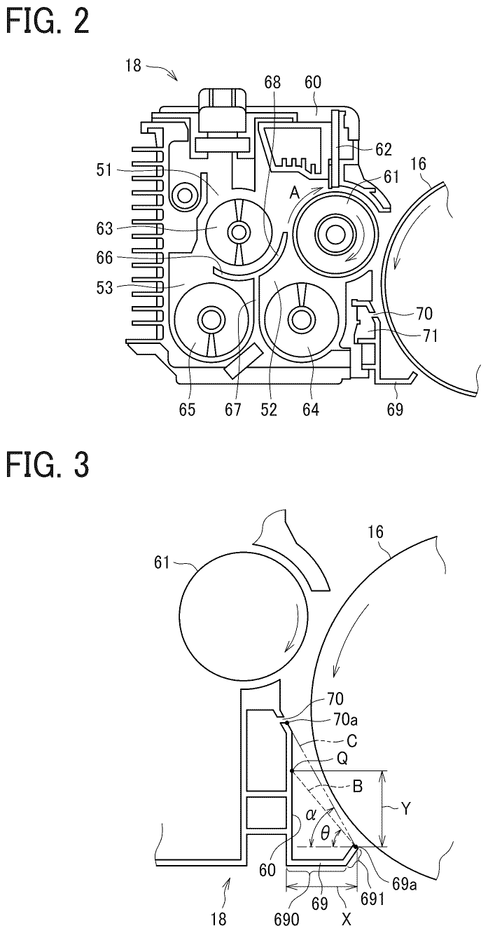

Next, a description is given of the configuration of the developing device 18 according to the first embodiment of the present disclosure with reference to FIG. 2. The developing devices 18 of the image forming units 10Y, 10M, 10C, and 10K have basically the same configuration except that the developing devices 18 contain toners of different colors.

For this reason, a description is given of the configuration of one developing device 18 illustrated in FIG. 2 as an example.

FIG. 2 is a schematic diagram illustrating the developing device 18 according to the first embodiment.

As illustrated in FIG. 2, the developing device 18 according to the first embodiment includes, for example, a housing 60 in which the developer is stored, a developing roller 61 to bear the developer on the circumferential surface of the developing roller 61, a regulation blade 62 to maintain the amount of the developer on the circumferential surface of the developing roller 61 to be constant, a supply conveyance screw 63, a collection conveyance screw 64, and a stirring conveyance screw 65. In the developing device 18 according to the first embodiment, a two-component developer containing toner and carrier is used as the developer.

The housing 60 includes a supply path 51 in which the supply conveyance screw 63 is accommodated, a collection path 52 in which the collection conveyance screw 64 is accommodated, and a stirring path 53 in which the stirring conveyance screw 65 is accommodated. The supply path 51, the collection path 52, and the stirring path 53 are partitioned from each other by a first partition 66, a second partition 67, and a third partition 68 disposed therebetween.

Specifically, the supply path 51 and the stirring path 53 are partitioned by a first partition 66 disposed therebetween. However, the supply path 51 and the stirring path 53 are not sufficiently partitioned by the first partition 66 and communicate with each other via two communication ports disposed on the front side and the back side in the longitudinal direction of the developing device 18, orthogonal to the surface of the paper on which FIG. 2 is drawn.

The collection path 52 and the stirring path 53 are separated by a second partition 67 disposed therebetween, and the collection path 52 and the stirring path 53 communicate with each other via a communication port disposed on the front side in the longitudinal direction of the developing device 18, orthogonal to the surface of the paper on which FIG. 2 is drawn.

By contrast, the supply path 51 and the collection path 52 are partitioned so as not to communicate with each other. In other words, the supply path 51 and the collection path 52 are continuously partitioned by the third partition 68 disposed therebetween from the front side to the rear side in the longitudinal direction of the developing device 18, orthogonal to the surface of the paper on which FIG. 2 is drawn.

The developing roller 61 is an example of a developer bearer that bears the developer on the circumferential surface of the developing roller 61. The developing roller 61 is disposed to be partially exposed from the housing 60 at a position (developing area) facing the photoconductor 16.

The regulation blade 62 is an example of a restricting member that maintains the amount of toner borne on the circumferential surface of the developing roller 61 to be constant. The regulation blade 62 is disposed to face the circumferential surface of the developing roller 61 with a predetermined gap therebetween.

The supply conveyance screw 63 is an example of a supply conveyor to convey the developer to be supplied to the developing roller 61. The supply conveyance screw 63 has a rotation shaft and a spiral blade on an outer peripheral surface of the rotation shaft and is driven to rotate to convey the developer. At this time, the supply conveyance screw 63 conveys the developer from the rear side to the front side in the longitudinal direction of the developing device 18, orthogonal to the surface of the paper on which FIG. 2 is drawn.

The collection conveyance screw 64 is an example of a collection conveyor that conveys collected developer. The collection conveyance screw 64 also has a rotary shaft and a spiral blade on the outer peripheral surface of the rotary shaft and is driven to rotate to convey the developer, similar to the supply conveyance screw 63.

At this time, the collection conveyance screw 64 conveys the developer from the rear side to the front side in the longitudinal direction of the developing device 18, orthogonal to the surface of the paper on which FIG. 2 is drawn, similar to the supply conveyance screw 63. The stirring conveyance screw 65 is an example of a stirring conveyor that conveys the developer while stirring the developer. The stirring conveyance screw 65 is also a conveyance screw that has a rotation shaft and a spiral blade on the outer peripheral surface of the rotation shaft and is driven to rotate to convey the developer, similar to the supply conveyance screw 63 and the collection conveyance screw 64.

However, the stirring conveyance screw 65 is different from the supply conveyance screw 63 and the collection conveyance screw 64 in that the stirring conveyance screw 65 conveys the developer in a direction different from the direction in which the supply conveyance screw 63 and the collection conveyance screw 64 convey the developer. In other words, the stirring conveyance screw 65 conveys the developer from the front side to the rear side in the longitudinal direction of the developing device 18, orthogonal to the surface of the paper on which FIG. 2 is drawn, which is opposite to the direction in which the supply conveyance screw 63 and the collection conveyance screw 64 conveys the developer.

### Operation of Developing Device

A description is given of the operation of the developing device 18 according to the first embodiment of the present disclosure.

In the developing device 18, when the developing roller 61 starts rotating, the developer is borne on the circumferential surface of the developing roller 61. Specifically, when the supply conveyance screw 63 conveys the developer from the rear side in the longitudinal direction of the developing device 18, orthogonal to the surface of the paper on which FIG. 2 is drawn, the toner of the developer is charged by friction with the carrier, and the charged toner is attracted and borne onto the circumferential surface of the developing roller 61 together with the carrier by the magnetic force of the developing roller 61.

When the developer, i.e., the toner and carrier, is borne on the circumferential surface of the developing roller 61, the developer moves in the rotation direction, indicated by arrow A in FIG. 2, of the developing roller 61 in accordance with the rotation of the developing roller 61. Thus, the developer reaches a position facing an end of the regulation blade 62. Subsequently, excessive developer is scraped off by the regulation blade 62, and the amount of the developer on the circumferential surface of the developing roller 61 is maintained to an appropriate amount.

Subsequently, the developer on the developing roller 61 reaches a position, i.e., the developing area, facing the photoconductor 16, and the toner on the developing roller 61 is transferred onto the electrostatic latent image on the photoconductor 16 by an electric field between the developing roller 61 and the photoconductor 16. Accordingly, the electrostatic latent image is developed as a toner image.

The developer that has passed through the position, i.e., the developing area, facing the photoconductor 16 is conveyed into the collection path 52 by the rotation of the developing roller 61, and is separated from the developing roller 61 in the collection path 52 and collected. The collection conveyance screw 64 conveys the collected developer from the rear side to the front side in the longitudinal direction of the developing device 18 orthogonal to the surface of the paper on which FIG. 2 is drawn, and the developer is conveyed into the stirring path 53 via the communication port on the front side.

Subsequently, the stirring conveyance screw 65 conveys the developer conveyed to the stirring path 53 from the front side to the rear side in the longitudinal direction of the developing device 18 orthogonal to the surface of the paper on which FIG. 2 is drawn, and the developer is conveyed to the supply path 51 via the communication port on the rear side.

A part of the developer that is conveyed to the supply path 51 is supplied to the developing roller 61 again while being conveyed by the supply conveyance screw 63. The remaining developer is returned to the stirring path 53 via the communication port on the front side in the longitudinal direction of the developing device 18 orthogonal to the surface of the paper on which FIG. 2 is drawn. Such a configuration as described above allows the developer to be circulated and conveyed between the supply path 51 and the stirring path 53.

### Toner Scattering

A description is given of toner scattering which may occur in the developing device 18 with reference to the configuration of the developing device 18 of the first embodiment illustrated in FIG. 2.

As illustrated in FIG. 2, in the developing device 18 according to the first embodiment, the developer borne on the developing roller 61 is conveyed to the position, i.e., the developing area, facing the photoconductor 16 in accordance with the rotation of the developing roller 61. However, at this time, some toner may not be supplied to the photoconductor 16 but may scatter to outside the housing 60 due to deterioration of the developer or the influence of the surrounding environment.

The scattered toner floats and then adheres to the outer face of the housing 60 of the developing device 18 or falls due to gravity and adheres to, for example, a device in the image forming apparatus 100. As a result, the inside of the image forming apparatus 100 may be contaminated.

In particular, in the image forming apparatus 100 of the first embodiment, the intermediate transfer belt 20 is disposed below the developing device 18 (see FIG. 1). For this reason, when the toner that adheres to the outer face of the housing 60 of the developing device 18 peels off due to, for example, the influence of vibration and falls onto the intermediate transfer belt 20, an image defect may be generated.

Accordingly, the developing device 18 of the first embodiment, as illustrated in FIG. 2, includes a suction port 70 for sucking the scattered toner and a toner receiver 69 for receiving the fallen toner.

The suction port 70 is disposed below the developing area where the developing roller 61 and the photoconductor 16 face each other and downstream from the developing area in the rotation direction of the developing roller 61. The toner receiver 69 is disposed below the developing area and further below the suction port 70.

The toner receiver 69 is preferably disposed at least over the entire width region of the developing roller 61 in the longitudinal direction (axial direction) such that the toner receiver 69 can receive the toner over the entire surface of the developing roller 61 in the longitudinal direction.

The suction port 70 communicates with a duct 71 disposed in the housing 60 of the developing device 18. Accordingly, the toner that is sucked from the suction port 70 is guided to the duct 71. The duct 71 is disposed to extend in the longitudinal direction (axial direction) of the developing roller 61.

In the developing device 18 of the first embodiment, multiple suction ports 70 are disposed in the longitudinal direction of the duct 71 (the longitudinal direction of the developing roller 61). However, the multiple suction ports 70 may be one opening continuous in the longitudinal direction of the duct 71 as long as the strength of the duct 71 can be secured.

The duct 71 is connected to a toner-dust collection path disposed in the body of the image forming apparatus 100 when the developing device 18 is mounted in the body of the image forming apparatus 100. A suction fan and a dust collection filter are disposed at an end of the toner-dust collection path, at an end of the toner-dust collection path opposite the duct 71. The suction fan generates a suction airflow as an airflow generator, and the dust collection filter captures toner.

Accordingly, when the suction fan is driven, a suction airflow is generated in the toner-dust collection path. By so doing, air is sucked into the duct 71 through the suction ports 70, and scattered toner inside the image forming apparatus 100 is sucked together with the air through the suction ports 70. The sucked toner is conveyed to the toner-dust collecting path in the body of the image forming apparatus 100 via the duct 71 and is captured by the dust collection filter disposed in the toner-dust collection path.

The toner that has not been collected by suction through the suction ports 70 and the toner that has peeled off and dropped from the outer face of the housing 60 are received by the toner receiver 69. Accordingly, the toner can be prevented from falling onto, for example, the intermediate transfer belt 20.

In the developing device 18 of the first embodiment that includes the toner receiver 69 below the suction port 70, when the toner accumulates in the toner receiver 69 as the developing device 18 is used, the height of the accumulated toner gradually increases toward the suction ports 70.

For this reason, if the suction ports 70 are blocked by the toner accumulated in the toner receiver 69, the suction function of the suction ports 70 is reduced, and the toner cannot be sufficiently sucked. As a result, the inside of the image forming apparatus 100 may be contaminated with the toner.

In addition, when the suction function of the suction ports 70 is reduced, the toner cannot be sucked by the suction ports 70. As a result, the amount of the toner accumulated in the toner receiver 69 increases. As a result, the toner receiver 69 is filled with the toner in a short time, and the toner that cannot be received by the toner receiver 69 falls. Accordingly, the inside of the image forming apparatus 100 may be contaminated.

As described above, when the suction ports 70 are blocked by the toner accumulated in the toner receiver 69, the scattered toner cannot be sufficiently collected by the suction ports 70, and the toner receiver 69 is filled with the toner in a short time. Therefore, a countermeasure that solves these disadvantages is necessary.

For this reason, the image forming apparatus 100 of the first embodiment has a following configuration in which the suction ports 70 can be prevented from being blocked by the accumulated toner. A description is given below of the configuration of the suction port 70 and the toner receiver 69 provided for the image forming apparatus 100 of the first embodiment.

### Configurations of Suction Port and Toner Receiver

FIG. 3 is a schematic diagram illustrating a configuration of the suction port 70 and the toner receiver 69 provided for the developing device 18, according to the first embodiment of the present disclosure.

In FIG. 3, a dotted line (ray) B that extends obliquely upward from an end 69a of the toner receiver 69 indicates the slope of the accumulated toner when the toner accumulates to the maximum in the toner receiver 69.

An “angle of repose” of the toner is represented by an inclination angle θ of the inclined surface of the toner (the ray B) when the toner accumulates to the maximum in the toner receiver 69. The “angle of repose” is the inclination angle θ of the inclined face of toner with respect to the horizontal line when the toner accumulates to the maximum without spontaneously collapsing. When the inclination angle θ of the inclined face of the toner exceeds the angle of repose, the toner collapses.

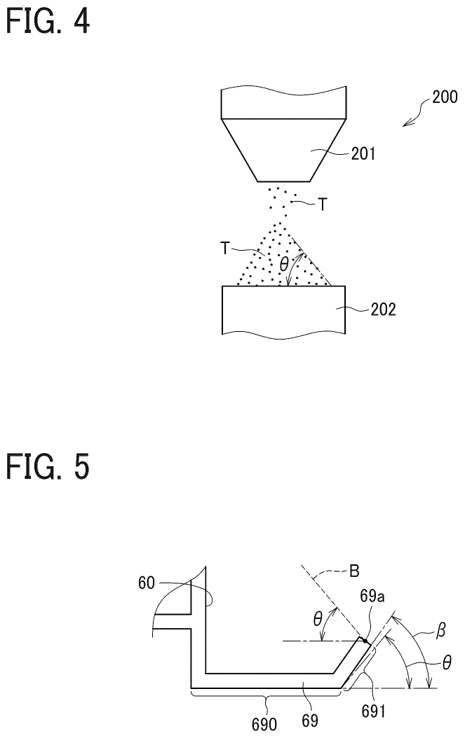

FIG. 4 is a schematic diagram illustrating a configuration of a bulk-density measuring device 200 for measuring the angle of repose of toner. The angle of repose of toner (the inclination angle of toner slope) θ can be measured by using, for example, the bulk-density measuring device 200, manufactured by Tokyo Garasu Kikai Co., Ltd., that includes a funnel 201 to funnel toner T and a table 202 to receive the fallen toner T as illustrated in FIG. 4.

For example, when the angle of repose θ of toner employed for a printer model ProC 5300 manufactured by Ricoh Company, Ltd. was measured using the bulk-density measuring device 200, the angle of repose θ was 50°.

From the value of the angle of repose θ of the toner T measured as described above, the position of vertex Q (see FIG. 3) of the toner accumulated to the maximum on the toner receiver 69 can be calculated.

More specifically, in the developing device 18 illustrated in FIG. 3, when a width X from the housing 60 to the end 69a of the toner receiver 69 is 7.5 mm, the angle of repose θ of toner is 50°. At this time, a height Y from the end 69a of the toner receiver 69 to the vertex Q of the toner accumulated to the maximum is 8.9 mm.

Accordingly, if the position of the suction ports 70 is higher than a height of 8.9 mm which is the height Y of the toner accumulated to the maximum, the suction ports 70 are not blocked by the accumulated toner.

For this reason, in the developing device 18 of the first embodiment of the present disclosure, in order to prevent the suction ports 70 from being blocked by the accumulated toner, the position of the suction ports 70 is set such that a line segment C connecting the end 69a of the toner receiver 69 and a lowermost end 70a of the suction port 70 is positioned above the ray B representing the inclined surface of the toner accumulated to the maximum in the toner receiver 69.

In other words, the suction ports 70 are disposed such that an angle α formed by the line segment C connecting the end 69a of the toner receiver 69 and the lowermost ends 70a of the suction ports 70 and a horizontal line extending horizontally from the end 69a of the toner receiver 69 toward the housing 60, is larger than the angle of repose θ of toner. Setting the angle α to be larger than the angle of repose θ of toner as described above allows the suction ports 70 to be disposed at a position higher than the vertex Q of the toner accumulated in the toner receiver 69. Accordingly, the suction ports 70 can be prevented from being blocked by the accumulated toner.

### Effect Confirmation Test

Next, a description is given of an effect confirmation test conducted to confirm the effect of embodiments of the present disclosure.

The effect confirmation test was performed with the image forming apparatus 100 of the first embodiment that employs the toner of the printer model ProC5300 manufactured by Ricoh Company, Ltd. The effect confirmation test was performed by printing 300,000 sheets of one set of 100 pages including 95 pages having an image coverage of 0.5% and 5 pages having an image coverage of 100%, which most likely to cause toner scattering.

As a result, in the configuration of the image forming apparatus 100 of the first embodiment, the toner did not fall from the toner receiver 69 even after 300,000 sheets were printed. As described above, the reason why the toner did not fall from the toner receiver 69 even after 300,000 sheets were printed is that the suction ports 70 were not blocked by the toner accumulated in the toner receiver 69.

In other words, the suction ports 70 are disposed at the position higher than the vertex Q of the toner accumulated to the maximum in the toner receiver 69. Accordingly, the suction ports 70 can be prevented from being blocked by the accumulated toner and can maintain the suction function favorably. Thus, the toner receiver 69 can be prevented from being filled up in a short time.

By contrast, when the same effect confirmation test was performed on the image forming apparatus 100 according to a comparative example different from the first embodiment of the present disclosure, the following results were obtained.

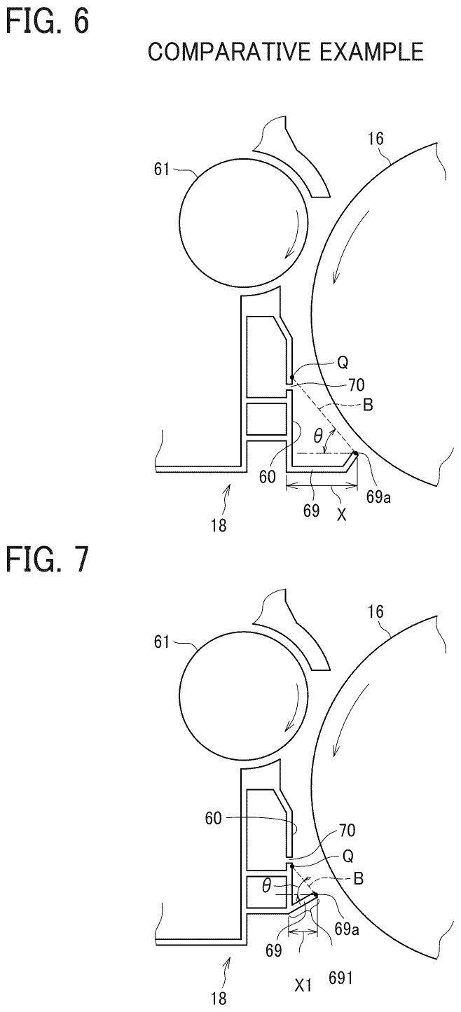

FIG. 6 is a diagram illustrating the developing device 18 according to a comparative example of embodiments of the present disclosure. As illustrated in FIG. 6, in the image forming apparatus 100 of the comparative example, the position of the suction ports 70 is lower than the vertex Q of the toner accumulated to the maximum in the toner receiver 69.

The configuration of the image forming apparatus 100, such as the width X from the housing 60 to the and 69a of the toner receiver 69, other than the height position of the suction ports 70, is the same as the configuration of the image forming apparatus 100 of the first embodiment of the present disclosure.

As a result, in the comparative example, the toner fell from the toner receiver 69 after 200,000 sheets were printed. The reason why such a result was obtained is that the suction ports 70 were blocked by the toner accumulated in the toner receiver 69 in the comparative example. In other words, the suction ports 70 are disposed at a position lower than the vertex Q of the toner accumulated to the maximum in the toner receiver 69. Accordingly, the suction ports 70 are blocked by the toner, the suction function of the suction ports 70 is deteriorated. Thus, the toner receiver 69 is filled up in a short time.

### Advantageous Effects of First Embodiment

As can be seen from the results of the above effect confirmation test, in the image forming apparatus 100 of the first embodiment of the present disclosure, the suction ports 70 can be prevented from being blocked by the toner accumulated in the toner receiver 69. By so doing, the function of the suction ports 70 can be favorably maintained, and the time until the toner receiver 69 becomes full can be extended.

Accordingly, the toner receiver 69 can receive the toner for a long period of time. For this reason, the toner can be prevented from falling from the toner receiver 69, and the inside of the image forming apparatus 100 can be prevented from being contaminated by the toner. In addition, in the image forming apparatus 100 of the first embodiment, the time until the toner receiver 69 becomes full can be extended. Accordingly, the frequency of performing the cleaning work of the toner receiver 69 can be reduced, and the workload can be reduced. In order to extend the time until the toner receiver 69 becomes full, it is effective to increase the bottom area of the toner receiver 69 such that the toner receiver 69 can hold a larger amount of toner, in addition to preventing the suction ports 70 from being blocked by the toner.

For this reason, in the image forming apparatus 100 of the first embodiment, as illustrated in FIG. 3, the toner receiver 69 has a horizontal portion 690 and an inclined portion 691 and has a shape defined by the horizontal portion 690 arranged horizontally and the inclined portion 691 arranged to be inclined obliquely upward from the horizontal portion 690.

FIG. 7 is a diagram illustrating a configuration of the developing device 18 according to a second embodiment of the present disclosure. The toner receiver 69 of the first embodiment has the horizontal portion 690 protruding from the housing 60. By so doing, the toner receiver 69 can hold a larger amount of toner than the configuration in which the toner receiver 69 of the second embodiment includes only the inclined portion 691 as illustrated in FIG. 7.

In other words, in the developing device 18 of the second embodiment illustrated in FIG. 7, the inclined portion 691 extends obliquely upward from the housing 60. For this reason, the end 69a of the toner receiver 69, i.e., the inclined portion 691, easily approaches the photoconductor 16. Thus, it is difficult to increase the size of the toner receiver 69.

By contrast, in the developing device 18 of the first embodiment, the toner receiver 69 extends in the horizontal direction in a lower region where the distance between the developing device 18 in the housing 60 and the photoconductor 16 is large. Accordingly, the toner receiver 69 can be effectively increased in size.

As a result, in the image forming apparatus 100 of the first embodiment, the bottom area of the toner receiver 69 can be increased, and the toner receiver 69 can hold a larger amount of toner.

In the example of FIG. 7, a distance X1 from the housing 60 to the end 69a of the toner receiver 69 is 4 mm, which is shorter than 7.5 mm of the distance X (see FIG. 3) of the toner receiver 69 of the first embodiment. Accordingly, when the effect confirmation test similar to the above-described effect confirmation test was performed, the toner receiver 69 became full when the number of printed sheets reached around 100,000 and the toner fell out of the toner receiver 69.

As described above, in the image forming apparatus 100 of the first embodiment, the toner receiver 69 has the horizontal portion 690 extending in the horizontal direction in the lower region where the distance between the developing device 18 (housing 60) and the photoconductor 16 is large. Accordingly, the bottom area of the toner receiver 69 is larger as compared with the example of FIG. 7. Thus, a larger amount of toner can be held in the toner receiver 69.

Such a configuration as described above can further extend the time until the toner receiver 69 becomes full. Accordingly, the inside of the image forming apparatus 100 can be prevented from being contaminated by toner for a longer period of time. At the same time, the frequency of performing, for example, the cleaning work of the toner receiver 69 can be reduced.

In the image forming apparatus 100 of the first embodiment, the lower face of the horizontal portion 690 is disposed at the same height as the lower face of the housing 60 in order to secure the bottom area of the toner receiver 69 as large as possible. In other words, the distance between the developing device 18 (the housing 60) and the photoconductor 16 is gradually widened downward. For this reason, the toner receiver 69 is disposed in an area having the distance as wide as possible.

Such a configuration as described above allows the toner receiver 69 to hold a larger amount of toner. Accordingly, the time until the toner receiver 69 becomes full can be effectively extended. The lower face of the horizontal portion 690 may be disposed at a position lower than the lower face of the housing 60. In this case, however, the toner receiver 69 protrudes downward from the housing 60. Accordingly, the toner receiver 69 may contact the surroundings and may be damaged when, for example, the developing device 18 is installed in the body of the image forming apparatus 100, or the developing device 18 may be difficult to hold by hand.

In the configuration in which the intermediate transfer belt 20 is disposed below the developing device 18, as in the image forming apparatus 100 of the first embodiment (see FIG. 1), when the toner receiver 69 protrudes downward from the housing 60, the toner receiver 69 approaches the intermediate transfer belt 20. For this reason, when the toner receiver 69 contacts the intermediate transfer belt 20, an image of the intermediate transfer belt 20 may be disturbed.

For this reason, in the image forming apparatus 100 of the first embodiment, the toner receiver 69 is prevented from protruding downward from the housing 60. Accordingly, the toner receiver 69 is prevented from being damaged, and the gripping performance of the developing device 18 is prevented from being lowered. Thus, image defects can be prevented from being generated due to the contact of the toner receiver 69 with the intermediate transfer belt 20.

The position of the lower face of the horizontal portion 690 is not limited to the same height at which the lower face of the housing 60 is positioned and may be disposed at substantially the same height as the lower face of the housing 60, for example, at a position slightly higher than the surface of the housing 60, as long as the lower face of the horizontal portion 690 does not protrude downward than the lower face of the housing 60.

However, if the end 69a of the toner receiver 69 is too close to the photoconductor 16, the inclined surface of the toner (indicated by the ray B in FIG. 3) accumulated on the toner receiver 69 may contact the surface of the photoconductor 16. Accordingly, the surface of the photoconductor 16 may be contaminated.

For this reason, in the image forming apparatus 100 of the first embodiment, the end 69a of the toner receiver 69 is positioned such that a half line, i.e., the ray B (dotted line) in FIG. 3, extending obliquely upward from the end 69a of the toner receiver 69 toward the housing 60 by the angle of repose θ of toner does not contact the surface of the photoconductor 16. Accordingly, even when toner accumulates to the maximum in the toner receiver 69, the inclined surface (the ray B) of the accumulated toner does not contact the surface of the photoconductor 16. Thus, the surface of the photoconductor 16 can be prevented from being contaminated.

In addition, in order to increase the amount of toner that can be held by the toner receiver 69, a vertical portion extending vertically upward may be disposed at an end of the horizontal portion 690 instead of the inclined portion 691 of the toner receiver 69. In this case, the horizontal portion 690 can be effectively extended. Accordingly, the amount of toner that can be held by the toner receiver 69 can be increased.

FIG. 5 is a diagram illustrating an inclination angle of the inclined portion 691 of the toner receiver 69 according to the first embodiment of the present disclosure. In the configuration in which the toner receiver 69 has the inclined portion 691, it is difficult to increase the amount of toner that can be held by the toner receiver 69. However, the toner can be prevented from falling beyond the end 69a. In other words, the toner receiver 69 has the inclined portion 691 and the end 69a at the end of the inclined portion 691. By so doing, the toner can be moved to the horizontal portion 690, closer to the housing 60 along the inclined surface of the inclined portion 691. Accordingly, the toner can be prevented from falling beyond the end 69a.

In order to effectively obtain the effect of preventing toner from falling by the inclined portion 691, as illustrated in FIG. 5, an inclination angle β of the inclined portion 691 with respect to the horizontal direction is preferably set to be larger than the angle of repose θ of toner. Such a configuration as described above allows the toner accumulated on the inclined portion 691 to easily collapse toward the horizontal portion 690. Accordingly, the toner can be more effectively prevented from falling beyond the end 69a.

Although the embodiments of the present disclosure have been described above, the present disclosure is not limited to the configurations according to the above-described embodiments, and design changes can be made as appropriate without departing from the gist of the disclosure.

In the above description, the example illustrated in FIG. 7 is given as an example of a configuration different from the first embodiment of the present disclosure. However, in this example, the suction ports 70 are disposed at a position higher than the vertex Q of the toner accumulated to the maximum in the toner receiver 69. Accordingly, the suction ports 70 can be prevented from being blocked by the toner accumulated in the toner receiver 69, similar to the first embodiment of the present disclosure. Therefore, the configuration of the developing device 18 illustrated in FIG. 7 may be employed as an embodiment (second embodiment) different from the first embodiment of the present disclosure.

In the above description, the developing device using the two component developer containing the toner and the carrier has been described as an example of the developing device 18 according to the first embodiment of the present disclosure. However, embodiments of the present disclosure are not limited to the developing device using the two component developer and can also be applied to a developing device using a one component developer formed of a magnetic toner containing magnetic powder.

Even in the developing device using such a one component developer, when the toner scatters or falls, the inside of the image forming apparatus 100 may be contaminated with the toner. Accordingly, applying embodiments of the present disclosure can prevent the suction ports 70 from being blocked by the toner. Thus, the inside of the image forming apparatus 100 can be prevented from being contaminated with the toner.

The above-described embodiments of the present disclosure have at least the following aspects.

### First Aspect

The developing device includes a housing to accommodate a developer containing at least toner, a developer bearer to bear the developer and supply toner to a latent image on an image bearer, a suction port to suck toner scattered outside the housing below the developer bearer, and a toner receiver to receive, below the developer bearer, toner scattered outside the housing or toner fallen outside the housing.

The suction port is disposed such that an angle formed by a line segment connecting an end of the toner receiver protruding from the housing and a lowermost end of the suction port and a horizontal line extending horizontally from the end of the toner receiver toward the housing is larger than the angle of repose of toner.

### Second Aspect

In the developing device according to the first aspect, the toner receiver has a horizontal portion and an inclined portion inclined obliquely upward from the horizontal portion, and an end of the inclined portion is the end of the toner receiver.

### Third Aspect

In the developing device according to the second aspect, an inclination angle of the inclined portion with respect to the horizontal direction is set to be larger than the angle of repose of toner.

### Fourth Aspect

In the developing device according to any one of the first to third aspects, the end of the toner receiver is positioned such that a half line extending obliquely upward toward the housing from the end of the toner receiver by the angle of repose of toner does not contact the surface of the image bearer.

### Fifth Aspect

In the developing device according to any one of the first to fourth aspects, a lower face of the toner receiver is positioned at substantially the same height as a lower face of the housing.

### Sixth Aspect

An image forming apparatus includes the developing device according to any one of the first to fifth aspects.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A developing device comprising:
a housing to contain a developer including at least toner;
an image bearer to form a latent image of the toner on a surface of the image bearer;
a developer bearer to bear the developer and supply the toner to the surface of the image bearer;
a suction port below the developer bearer to suck the toner outside the housing; and
a toner receiver below the suction port to receive the toner outside the housing,
wherein the toner receiver has a first angle between:
a line segment connecting a tip end of the toner receiver protruding from the housing and a lowermost end of the suction port; and
a horizontal line extending horizontally from the tip end of the toner receiver toward the housing,
the toner receiver receives the toner having an angle of repose as a second angle, and
the first angle is larger than the second angle.

2. The developing device according to claim 1,
wherein the toner receiver includes:
a horizontal portion connected to the housing at one end of the horizontal portion; and
an inclined portion inclined obliquely upward from the horizontal portion at another end of the horizontal portion, and
the inclined portion having the tip end facing the image bearer.

3. The developing device according to claim 2,
wherein the inclined portion has a third angle with respect to the horizontal portion, and
the third angle is larger than the second angle.

4. The developing device according to claim 1,
wherein the toner receiver has a ray extending obliquely upward from the tip end toward the housing by the second angle, and
the ray is separated from the surface of the image bearer.

5. The developing device according to claim 1,
wherein a lower face of the horizontal portion of the toner receiver is positioned at the same height as a lower face of the housing.

6. An image forming apparatus comprising the developing device according to claim 1.
